(19) United States
(12) Patent Application Publication
(10) Pub. No.: US 2015/0177468 A1
(43) Pub. Date: Jun. 25, 2015

(54) OPTICAL CONNECTOR

(71) Applicant: DELTA ELECTRONICS, INC., Taoyuan Hsien (TW)

(72) Inventors: Yu-Hsien LIAO, Taoyuan Hsien (TW); Hong-Bin YOU, Taoyuan Hsien (TW); Gow-Zin YIU, Taoyuan Hsien (TW)

(21) Appl. No.: 14/473,414

(22) Filed: Aug. 29, 2014

(30) Foreign Application Priority Data
Dec. 20, 2013 (CN) 201310706459.9

(51) Int. Cl. G02B 6/42

(52) U.S. Cl. CPC G02B 6/428; G02B 6/4206

(57) ABSTRACT

An optical connector is disclosed. The optical connector has a casing, a circuit structure, a lens structure and an optical transceiver element. The circuit structure is disposed inside the casing and configured for transmitting an electrical signal. The lens structure is directly fixed on the casing and coupled to a fiber adapter. The optical transceiver element is disposed on the circuit structure, and an optical signal is transmitted between the optical transceiver element and the fiber adapter through the lens structure.

### CROSS REFERENCE TO RELATED APPLICATIONS

This Non-provisional application claims priority under 35 U.S.C. §119(a) on Patent Application No(s). 201310706459.9 filed in People's Republic of China on Dec. 20, 2013, the entire contents of which are hereby incorporated by reference.

### BACKGROUND OF THE INVENTION

1. Field of Invention

The present invention relates to an optical connector.

2. Related Art

Recently, the data processing speed and amount have been explosive increased, so the traditional cable may not afford and provide the desired bandwidth and transmission speed. Accordingly, the optical fiber is introduced to the data transmission and communication applications.

The optical transmission through fibers has the advantages of no limitation in bandwidth, high speed transmission, longer transmission distance, and free from the electromagnetic interference. In general fiber communication, the optical signal travels through the fiber and reaches an optical transceiver, and then the optical signal is converted into an electric signal; otherwise, the optical transceiver may convert the electric signal of the circuit board into an optical signal, and then the optical signal is transmitted through the fiber.

As mentioned above, the optical transceiver used in fiber communication is usually packaged by COB (Chip on Board) process. The COB process can align and couple the lens to the optical transceiver. After the die bonding process, the lens directly covers on the optical transceiver. However, the conventional lens only connects to the circuit board, so it may have displacement with respect to the optical transceiver as the fiber continuously applies force thereon (or pushes) in the following applications. This displacement will decrease the coupling efficiency so as to vary the output power, thereby failing in the desired transmission distance and data transmission stability.

Therefore, it is an important subject to provide an optical connector that can resist the force of plugging/unplugging the fiber, increase the data transmission stability, and have simplified structure and manufacturing process.

### SUMMARY OF THE INVENTION

In view of the foregoing subject, an objective of the present invention is to provide an optical connector that can resist the force of plugging/unplugging the fiber and prevent the decrease of the coupling efficiency, which usually results in the variation of the output power. Another objective of the present invention is to provide an optical connector that can increase the data transmission stability and have simplified structure and manufacturing process.

To achieve the above objectives, an optical connector of the present invention includes a casing, a circuit structure, a lens structure and an optical transceiver element.

The circuit structure is disposed inside the casing and configured for transmitting an electrical signal. The lens structure is directly fixed on the casing and coupled to a fiber adapter. The optical transceiver element is disposed on the circuit structure, and an optical signal is transmitted between the optical transceiver element and the fiber adapter through the lens structure.

In one embodiment, the lens structure is fixed on the casing via a connecting structure.

In one embodiment, the material of the connecting structure includes an adhesive, a packing material, an elastic material or a soft material.

In one embodiment, the circuit structure has at least a pin for electrically connecting to an external system.

In one embodiment, the lens structure includes a main body and at least an extending portion, and the lens structure is fixed on the casing via the extending portion.

In one embodiment, the lens structure is fixed on the casing by embedding, wedging or locking.

In one embodiment, the circuit structure and the lens structure are individually fixed on the casing.

In one embodiment, the circuit structure and the lens structure are directly connected.

As mentioned above, the lens structure of the invention is directly coupled to the casing, so that the force of the plugging/unplugging fiber can be conducted from the lens structure to the casing, thereby preventing the force focusing at the optical transceiver and the circuit structure, which may cause the undesired relative displacement thereof and affect the alignment and light coupling.

### BRIEF DESCRIPTION OF THE DRAWINGS

The present invention will become more fully understood from the subsequent detailed description and accompanying drawings, which are given by way of illustration only, and thus are not limitative of the present invention, and wherein:

FIG. 1 is a schematic diagram showing an optical connector according to embodiment of the present invention; and

FIG. 2 is a sectional view of the optical connector along the line AA of FIG.

### DETAILED DESCRIPTION OF THE INVENTION

The present invention will be apparent from the following detailed description, which proceeds with reference to the accompanying drawings, wherein the same references relate to the same elements.

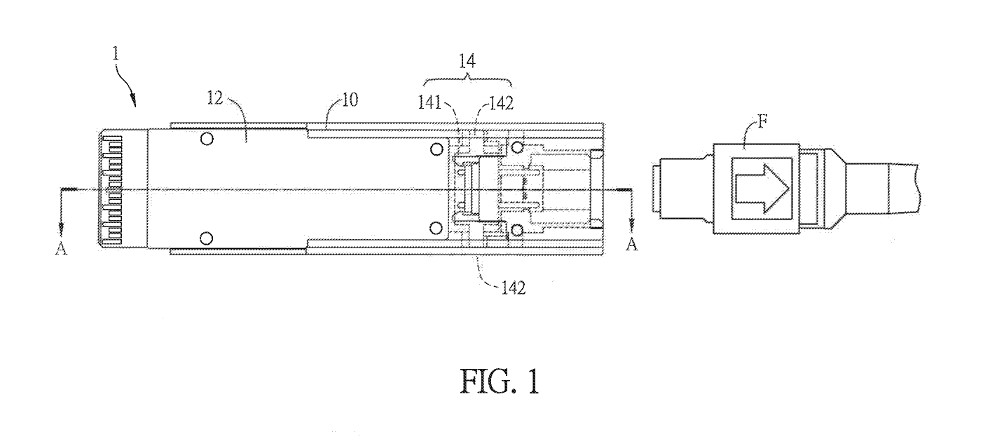

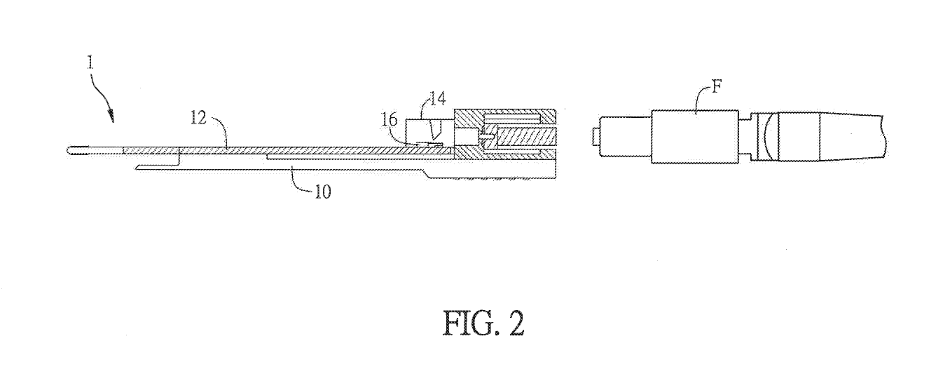

FIG. 1 is a schematic diagram showing an optical connector 1 according to an embodiment of the present invention, and FIG. 2 is a sectional view of the optical connector 1 along the line AA of FIG. 1.

Referring to FIGS. 1 and 2, the optical connector 1 includes a casing 10, a circuit structure 12, a lens structure 14 and an optical transceiver element 16.

For example, the casing 10 can be made of plastic, metal, stainless steel, alloy, ceramic, or any other material with sufficient rigidity. Besides, the casing 10 can be connected to other components by adhesion, wedging, embedding, fitting, clipping, filling or using at least one bolt, or they can be integrally formed as one piece.

The circuit structure 12 is disposed inside the casing 10 and is configured for transmitting electric signals. Moreover, the circuit structure 12 may further include at least one pin for electrically connecting to an external system. In this embodiment, the circuit structure is, for example but not limited to, a printed circuit board. Except for directly fixing to the circuit structure 12, the casing 10 may cover the optical transceiver element 16 so as to indirectly fix to the circuit structure 12. This invention is not limited thereto.

The lens structure 14 can be directly fixed on the casing 10 and coupled to the fiber adapter F.

The optical transceiver element 16 is disposed on the circuit structure 12, and the optical signals can be transmitted between the optical transceiver element 16 and the fiber adapter F through the lens structure 14. In other words, the lens structure 14 is directly fixed on the casing 10. In this embodiment, the fiber adapter F and the lens structure 14 are directly connected, and the optical transceiver element 16 can convert the electric signals to optical signals and then output the optical signals through the fiber adapter F.

In this embodiment, the optical transceiver element 16 is configured by COB process. That is, the optical transceiver element 16 is directly mounted on the circuit structure 12. The COB process is benefit in that the size of the optical connector 1 can be minimized.

The lens structure 14 is fixed and coupled to the casing 10 through a connecting structure (not shown). Herein, the material of the connecting structure can include an adhesive, a packing material, an elastic material or a soft material for fixing and coupling the lens structure 14 on the casing 10.

To be noted, it is also possible to utilize a structure design in cooperating with a proper connecting structure for enhancing the bonding force between the lens structure 14 and the casing 10. For example, the combination of a wedging structure and an adhesive can sufficiently enhance the bonding force between the lens structure 14 and the casing 10.

In more detailed, the lens structure 14 includes a main body 141 and at least one extending portion 142, and the lens structure 14 is fixed on the casing 10 via the extending portion 142. In this embodiment, the lens structure 14 includes two extending portions 142, which are disposed at two sides of the main body 141 and extended into the trenches of the casing 10 for fixing and coupling. Accordingly, when the fiber adapter F continuously applies force (pushes) the lens structure 14, the applied force can be spread to the casing 10 through the extending portions 142. Thus, the displacement of the circuit structure 12 is not generated due to the applied force, thereby maintaining the relative positions of the optical transceiver element 16 and the lens structure 14.

Different from the aspect shown in the figures, the extending portions 142 of the lens structure 14 may have a wedge structure, and the size of the extending portions 142 can be modified. Herein, the larger size of the extending portions 142 can stand and spread more applied force.

In addition, the extending portion 142 may further include a pivotal hole (not shown). Accordingly, the lens structure 14 can be directly fixed on the casing 10 through the pivotal hole of the extending portion 142 by screw, rivet or any equivalent fixing member. This configuration can further enhance the connection between the lens structure 14 and the casing 10, thereby precisely maintaining the relative positions of the optical transceiver element 16 and the lens structure 14.

The present invention simply configures an extending portion 142 on the lens structure 14 to replace the conventional connection method such as adding an additional reinforced member (for spreading force) or jumping cable (for indirectly connecting the lens structure 14 and the fiber adapter F). Accordingly, the optical connector 1 of the embodiment has simple structure, less components and simplified manufacturing process, thereby decreasing the production speed and cost.

In addition, the optical transceiver element 16 further includes a laser diode package functioned as an optical transmission element. However, the optical transmission element of the optical connector 1 is not limited to the above-mentioned laser diode package, and in other aspects, it can be any one selected from the group consisting of the planar waveguide, vertical-cavity surface-emitting laser, LED, photo diode or other light-emitting devices.

The laser diode of the optical transceiver element 16 can be connected to the circuit structure 12 by wire bonding, integral formation or embedding. Herein, the integral formation means that the laser diode package and the circuit structure 12 are simultaneously or individually formed in the same or a single structure.

In summary, the lens structure of the invention is directly coupled to the casing, so that the three of the plugging/unplugging fiber can be conducted from the lens structure to the casing, thereby preventing the force focusing at the circuit structure, which may cause the undesired relative displacement of the lens structure and the optical transceiver element and affect the alignment and light coupling.

According to the above configuration, the present invention can provide an optical connector that can resist the force of plugging/unplugging the fiber and prevent the decrease of the coupling efficiency, which usually results in the variation of the output power. In addition, the optical connector of the present invention can increase the data transmission stability and have simple structure and simplified manufacturing process.

Although the present invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the present invention.

What is claimed is:

1. An optical connector, comprising:
a casing;
a circuit structure disposed inside the casing and configured for transmitting an electrical signal;
a lens structure directly fixed on the casing and configured for coupling o a. fiber adapter; and
an optical transceiver element disposed on the circuit structure, wherein an optical signal is transmitted between the optical transceiver element and the fiber adapter through the lens structure.

2. The optical connector according to claim 1, wherein the lens structure is fixed on the casing via a connecting structure.

3. The optical connector according to claim 2, wherein the material of the connecting structure comprises an adhesive, a packing material, an elastic material or a soft material.

4. The optical connector according to claim 1, wherein the circuit structure has at least a pin for electrically connecting to an external system.

5. The optical connector according to claim 1, wherein the lens structure comprises a main body and at least an extending portion, and the lens structure is fixed on the casing via the extending portion.

6. The optical connector according to claim 1, wherein the lens structure is fixed on the casing by embedding, wedging or locking.

7. The optical connector according to claim 1, wherein the circuit structure and the lens structure are individually fixed on the casing.

8. The optical connector according to claim 1, wherein the circuit structure and the lens structure are directly connected.
